(19) United States
(12) Patent Application Publication
(10) Pub. No.: US 2012/0127518 A1
(43) Pub. Date: May 24, 2012

(54) POWER-SUPPLY MONITORING DEVICE AND IMAGE PROCESSING APPARATUS

(75) Inventors: Kenta OGATA, Kanagawa (JP); Kazuhiko Narushima, Kanagawa (JP); Motofumi Baba, Kanagawa (JP); Masafumi Ono, Kanagawa (JP); Mitsunobu Mamiya, Kanagawa (JP); Kenji Kuroishi, Kanagawa (JP); Masato Ishiyama, Kanagawa (JP); Keiko Shiraishi, Kanagawa (JP); Kouichi Azuma, Kanagawa (JP); Hidenori Horie, Kanagawa (JP)

(73) Assignee: FUJI XEROX CO., LTD., Tokyo (JP)

(21) Appl. No.: 13/174,968

(22) Filed: Jul. 1, 2011

(30) Foreign Application Priority Data
Nov. 19, 2010 (JP) 2010-259236

(51) Int. Cl. G06F 15/00; H02J 4/00

(52) U.S. Cl. 358/1.15; 323/318

(57) ABSTRACT

A power-supply monitoring device includes a power-supply control section, a detection section, a determination section, a control section, and an attachment section. The power-supply control section receives supply of power from a mains power source section, and selectively sets a power supply mode and a power saving mode. The detection section detects, in a predetermined region, a body capable of movement including a user who intends to use a processing section. When the body capable of movement is detected, the determination section determines whether switching from the power saving mode to the power supply mode is to be performed to obtain a result. The control section controls the power-supply control section on the basis of the result. The attachment section is attached to the detection section so that a detection region including a position or having an area for identifying the user is adjustable.

### CROSS-REFERENCE TO RELATED APPLICATIONS

This application is based on and claims priority under 35 USC 119 from Japanese Patent Application No. 2010-259236 filed Nov. 19, 2010.

### BACKGROUND

### (i) Technical Field

The present invention relates to a power-supply monitoring device and an image processing apparatus.

### SUMMARY

According to an aspect of the invention, there is provided a power-supply monitoring device including a power-supply control section, a detection section, a determination section, a control section, and an attachment section. The power-supply control section receives supply of power from a mains power source section, and selectively sets a power supply mode and a power saving mode. In the power supply mode, power is supplied to a processing section that operates using power supplied from the mains power source section. In the power saving mode, supply of power to the processing section is stopped. The detection section detects a body capable of movement in a predetermined region which is set in a periphery of the processing section. The body capable of movement includes a user who intends to use the processing section. When the body capable of movement is detected by the detection section, the determination section determines whether or not switching from the power saving mode to the power supply mode is to be performed. The control section controls the power-supply control section on the basis of a result of determination performed by the determination section. The attachment section is attached to the detection section so that a detection region is adjustable. The detection region includes a position or has an area for identifying the user who intends to use the processing section.

### BRIEF DESCRIPTION OF THE DRAWINGS

Exemplary embodiment(s) of the present invention will be described in detail based on the following figures, wherein:

FIG. 1 is a schematic diagram of an image processing apparatus according to the present exemplary embodiment;

FIG. 2 is a diagram schematically illustrating a configuration of a main controller and a power-source device in the present exemplary embodiment;

FIG. 3A is a perspective view illustrating an attachment structure of a human-presence sensor, which is attached onto the underside of an image reading section, and the periphery of the human-presence sensor;

FIG. 3B is an enlarged perspective view of FIG. 3A;

FIG. 4A illustrates a front view of a mask in which multiple openings having different opening areas are formed;

FIG. 4B illustrates a perspective view illustrating detection regions corresponding to the individual openings;

FIG. 5A illustrates a front view of a mask in which multiple openings having opening positions that are shifted to the left and right sides so that a circle corresponding to a detection face and the openings are relatively eccentric are formed;

FIG. 5B illustrates a perspective view illustrating detection regions corresponding to the individual openings (in a case in which an integrated circuit (IC) card reader is attached);

FIG. 6A illustrates a front view of a mask in which multiple openings having opening positions that are shifted in the depth direction so that the circle corresponding to the detection face and the openings are relatively eccentric are formed;

FIG. 6B illustrates a perspective view illustrating detection regions corresponding to the individual openings;

FIG. 7A illustrates a front view of a mask in which multiple openings having different opening positions, different opening shapes, different opening areas, and so forth are formed without restriction;

FIG. 7B illustrates a perspective view illustrating detection regions corresponding to the individual openings (in a case in which an optional device is attached); and

FIG. 8 illustrates an example of a human-presence sensor that is a reflection-type sensor including a light-projecting unit and a light-receiving unit.

### DETAILED DESCRIPTION

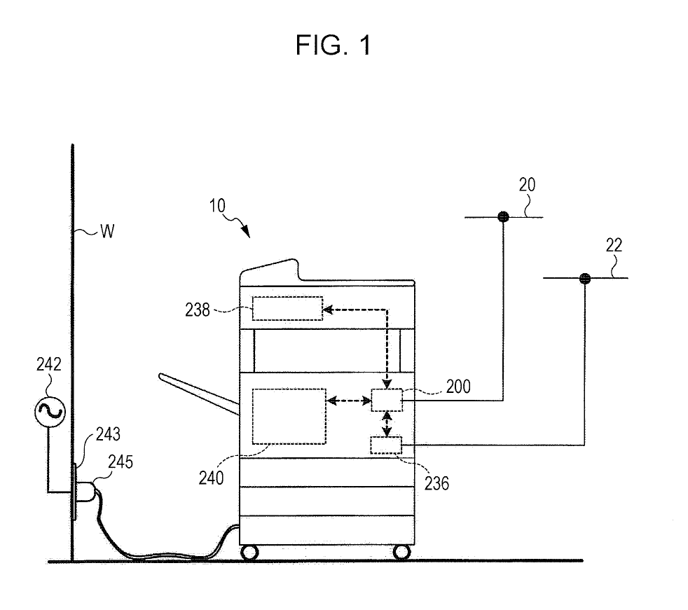

FIG. 1 illustrates an image processing apparatus 10 according to the present exemplary embodiment. The image processing apparatus 10 includes an image forming section 240 that forms an image on a recording sheet, an image reading section 238 that reads a document image, and a facsimile-communication control circuit 236. The image processing apparatus 10 includes a main controller 200. The main controller 200 controls the image forming section 240, the image reading section 238, and the facsimile-communication control circuit 236, thereby temporarily storing image data regarding a document image read by the image reading section 238 or transmitting the read image data to the image forming section 240 or to the facsimile-communication control circuit 236.

A network-communication network 20 such as the Internet is connected to the main controller 200. A telephone network 22 is connected to the facsimile-communication control circuit 236. The main controller 200 is connected to, for example, a host computer, via the network-communication network 20. The main controller 200 has a function of receiving image data and a function of performing facsimile reception and facsimile transmission using the telephone network 22 via the facsimile-communication control circuit 236.

The image forming section 240 includes a photoconductor drum. Around the photoconductor drum, a charging device, a scanning exposure unit, an image development unit, a transfer unit, and a cleaning unit are provided. The charging device uniformly charges the photoconductor drum. The scanning exposure unit scans the photoconductor using a light beam on the basis of image data. The image development unit develops an electrostatic latent image that has been formed by scanning the photoconductor drum with the scanning exposure unit so as to expose the photoconductor drum to the light beam. The transfer unit transfers, onto a recording sheet, an image that has been visualized on the photoconductor drum. The cleaning unit cleans the surface of the photoconductor drum after transfer is performed by the transfer unit. Furthermore, a fixing unit that fixes the image which has been transferred onto the recording sheet is provided along a path along which the recording sheet is transported.

In the image reading section 238, a document plate, a scanning drive system, and photoelectric conversion elements are provided. On the document plate, positioning of a document is performed. The scanning drive system scans an image formed on the document that is placed on the document plate, thereby irradiating the image with light. The photoelectric conversion elements, such as CCDs, receive reflected light or transmitted light, which are obtained by scanning the image with the scanning drive system, and convert the reflected light or transmitted light into electric signals.

Regarding the image processing apparatus 10, a plug 245 is also attached to an end of an input power line 244. The plug 245 is inserted in a plug plate 243 of a mains power source 242 for which installation of wires to a wall surface W is performed, thereby receiving supply of power.

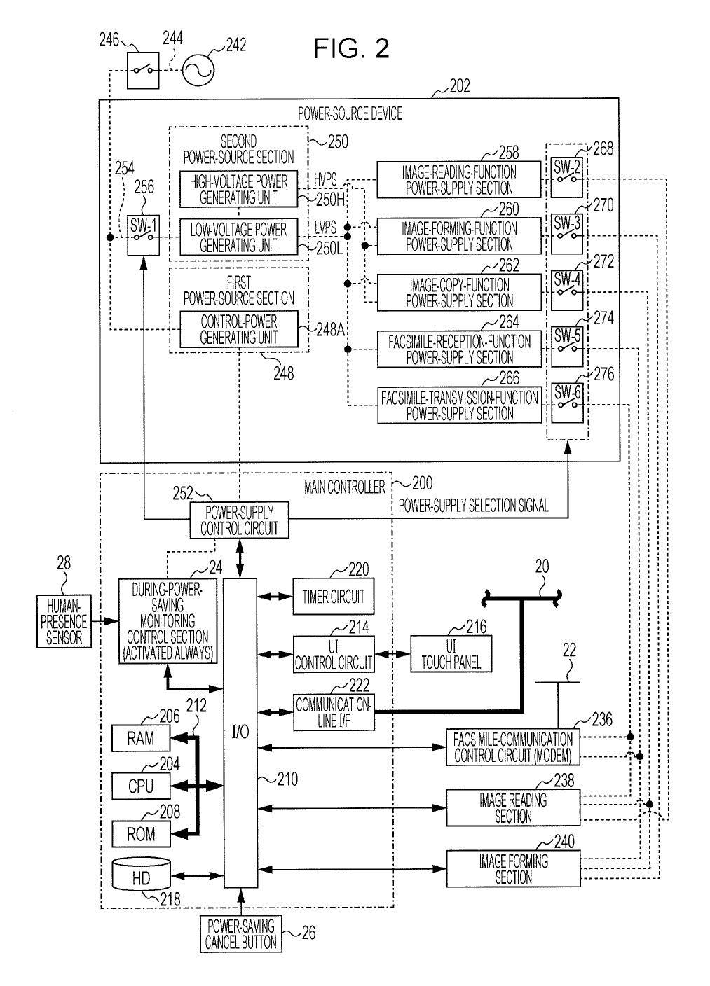

FIG. 2 is a diagram schematically illustrating a configuration in which devices controlled by the main controller 200, the main controller 200, and power lines of a power-source device 202 used to supply power to the individual devices, and so forth are provided.

### Main Controller 200

As illustrated in FIG. 2, the main controller 200 includes a central processing unit (CPU) 204, a random-access memory (RAM) 206, a read-only memory (ROM) 208, an input/output (I/O) (input/output section) 210, and a bus 212 including a data bus, a control bus, and so forth that are used to connect the CPU 204, the RAM 206, the ROM 208, the I/O 210 to each other. A user interface (UI) touch panel 216 is connected to the I/O 210 via a UI control circuit 214. Furthermore, a hard disk (HDD) 218 is connected to the I/O 210. The CPU 204 operates in accordance with a program recorded in the ROM 208, the hard disk 218, or the like, thereby realizing functions of the main controller 200. Note that the program may be installed from a recording medium (a compact disc read-only memory (CD-ROM), a digital versatile disk read-only memory (DVD-ROM), or the like) on which the program is stored, and the CPU 204 may operate in accordance with the program, whereby image processing functions may be realized.

A timer circuit 220 and a communication-line interface (I/F) 222 are connected to the I/O 210. Furthermore, the individual devices, which are the facsimile-communication control circuit (a modem) 236, the image reading section 238, and the image forming section 240, are connected to the I/O 210.

Note that, the timer circuit 220 counts an initial setting time as a trigger for setting the facsimile-communication control circuit 236, the image reading section 238, and the image forming section 240 to be in a power-saving state (a state in which power is not supplied).

Power is supplied from the power-source device 202 to the main controller 200 and the individual devices (the facsimile-communication control circuit 236, the image reading section 238, and the image forming section 240) (see dotted lines illustrated in FIG. 2). Note that, although one line (a dotted line) is illustrated as a power line in FIG. 2, the power line includes a few wiring lines in reality.

### Power-Source Device 202

As illustrated in FIG. 2, the input power line 244, which is routed from the mains power source 242, is connected to a main switch 246. The main switch 246 is turned on, whereby supply of power to a first power-source section 248 and a second power-source section 250 becomes enabled.

The first power-source section 248 includes a control-power generating unit 248A. The control-power generating unit 248A is connected to a power-supply control circuit 252 of the main controller 200. The power-supply control circuit 252 supplies power to the main controller 200, and is connected to the I/O 210. The power-supply control circuit 252 performs, in accordance with a control program executed by the main controller 200, switching control for causing electricity to be conducted/not conducted through power-supply lines through which power is supplied to the individual devices (the facsimile-communication control circuit 236, the image reading section 238, and the image forming section 240).

In contrast, regarding a power line 254 that is to be connected to the second power-source section 250, a first sub-power-source switch 256 (hereinafter, referred to as a “SW-1” in some cases) is intervened between the power line 254 and the second power-source section 250. The SW-1 is controlled by the power-supply control circuit 252 so as to be turned on/off.

Furthermore, the second power-source section 250 includes a high-voltage power generating unit 250H and a low-voltage power generating unit (LVPS) 250L. The high-voltage power generating unit 250H is a power source that is used, for example, for a heater of the fixing unit of the image forming section 240 and so forth. Power for the high-voltage power generating unit 250H is generated by the low-voltage power generating unit 250L.

The high-voltage power generating unit 250H and the low-voltage power generating unit (LVPS) 250L of the second power-source section 250 are selectively connected to an image-reading-function power-supply section 258, an image-forming-function power-supply section 260, an image-copy-function power-supply section 262, a facsimile-reception-function power-supply section 264, and a facsimile-transmission-function power-supply section 266.

The image-reading-function power-supply section 258 uses the low-voltage power generating unit (LVPS) 250L as an input source, and is connected to the image reading section 238 via a second sub-power-source switch 268 (hereinafter, referred to as a “SW-2” in some cases).

The image-forming-function power-supply section 260 uses the high-voltage power generating unit 250H and the low-voltage power generating unit (LVPS) 250L as input sources, and is connected to the image forming section 240 via a third sub-power-source switch 270 (hereinafter, referred to as a “SW-3” in some cases).

The image-copy-function power-supply section 262 uses the high-voltage power generating unit 250H and the low-voltage power generating unit (LVPS) 250L as input sources, and is connected to the image reading section 238 and the image forming section 240 via a fourth sub-power-source switch 272 (hereinafter, referred to as a “SW-4” in some cases).

The facsimile-reception-function power-supply section 264 uses the high-voltage power generating unit 250H and the low-voltage power generating unit (LVPS) 250L as input sources, and is connected to the facsimile-communication control circuit 236 and the image forming section 240 via a fifth sub-power-source switch 274 (hereinafter, referred to as a “SW-5” in some cases).

The facsimile-transmission-function power-supply section 266 uses the low-voltage power generating unit (LVPS) 250L as an input source, and is connected to the facsimile-communication control circuit 236 and the image reading section 238 via a sixth sub-power-source switch 276 (hereinafter, referred to as a “SW-6” in some cases) (output of a communication report and so forth is excluded).

As in the case of the first sub-power-source switch 256, each of the second sub-power-source switch 268, the third sub-power-source switch 270, the fourth sub-power-source switch 272, the fifth sub-power-source switch 274, and the sixth sub-power-source switch 276 is controlled, in accordance with a power-supply selection signal supplied from the power-supply control circuit 252 of the main controller 200, so as to be turned on/off.

In the above-described configuration, the power sources connected so as to select the individual devices (the facsimile-communication control circuit 236, the image reading section 238, and the image forming section 240) on a function-by-function basis are provided, and power is not supplied to devices that are not necessary for a specified function. Accordingly, minimum necessary power is only necessary.

### Monitoring During Power Saving Mode

Here, regarding the main controller 200 in the present exemplary embodiment, in some cases, the functions thereof are partially stopped in order to consume minimum necessary power. Alternatively, in some cases, supply of power to elements including most sections of the main controller 200 is stopped. Such cases are collectively referred to a “power saving mode”. A during-power-saving monitoring control section 24 is provided as an element that always receives supply of power during the power saving mode, and is connected to the I/O 210. The during-power-saving monitoring control section 24 may be configured using, for example, an integrated circuit (IC) chip, which is referred to as an “application-specific integrated circuit (ASIC)”, in which an operation program is stored, and which includes a CPU, a RAM, a ROM, and so forth that are processed in accordance with the operation program.

When monitoring during the power saving mode is performed, it is supposed that, for example, an operation is performed on the UI touch panel 216 or an operation is performed on so-called hard keys (for example, operation buttons for providing a copy instruction, a facsimile instruction, and so forth), and, in accordance with the operation, the during-power-saving monitoring control section 24 controls the first sub-power-source switch 256, the second sub-power-source switch 268, the third sub-power-source switch 270, the fourth sub-power-source switch 272, the fifth sub-power-source switch 274, and the sixth sub-power-source switch 276, thereby supplying power to devices that have been set in the power saving mode.

Furthermore, a power-saving cancel button 26 is connected to the I/O 210 of the main controller 200. A user performs an operation on the power-saving cancel button 26 during the power saving mode, whereby power saving can be cancelled.

Here, in order to monitor an operation performed on the UI touch panel 216 or an operation performed on the so-called hard keys (including the power-saving cancel button 26), which are described above, it is supposed that power is supplied to the UI touch panel 216 of the main controller 200 and so forth in addition to the during-power-saving monitoring control section 24.

Accordingly, in reality, even during the power saving mode, minimum necessary power that is, for example, necessary for input systems including the UI touch panel 216 is supplied.

Furthermore, when a user stands in front of the image processing apparatus 10, and, then, performs an operation on the power-saving cancel button 26, thereby resuming supply of power, there are some cases in which it takes time until the image processing apparatus 10 becomes activated.

For this reason, in the present exemplary embodiment, for reduction of the amount of power supplied to the main controller 200 by monitoring during the above-described power saving mode, in order to further reduce the amount of power supplied to the main controller 200, a human-presence sensor 28 is provided in the during-power-saving monitoring control section 24. In the power saving mode, supply of power to sections excluding the human-presence sensor 28 and the during-power-saving monitoring control section 24 is interrupted.

Note that, regarding the human-presence sensor 28, the term “human presence” is used. However, the term “human presence sensor” is a proper noun used in accordance with the present exemplary embodiment. The human-presence sensor at least needs to detect a person. In other words, the human-presence sensor may also detect a body capable of movement other than a person. Accordingly, in the description give below, there are some cases in which a target to be detected by the human-presence sensor is a “person”. However, in the future, a robot or the like that performs an operation instead of a person may be included in examples of a target to be detected by the human-presence sensor. Note that, in contrast, when a specific sensor capable of exclusively detecting a person exists, the specific sensor may be applied.

The specification of the human-presence sensor 28 includes detection of movement of a person in the periphery of the image processing apparatus 10. In this case, the human-presence sensor 28 is typified by, for example, an infrared ray sensor using a pyroelectric effect of a pyroelectric element.

The most distinctive feature of such a sensor using a pyroelectric effect of a pyroelectric element is that the detection region thereof is large. Furthermore, because the sensor detects movement of a person, when a person is standing still in a detection region, the sensor does not detect the existence of the person. For example, supposing that a high-level signal is output when a person moves, when the person becomes still in the detection region, the signal changes from the high-level signal to a low-level signal.

As a matter of course, the meaning of the term “still” in the present exemplary embodiment also includes a state in which a person is completely still, as in a still image captured by a still camera or the like. However, for example, the meaning of the term “still” also includes a state in which a person is standing still in front of the image processing apparatus 10 for the sake of performing an operation. Accordingly, the meaning of the term “still” includes a state in which a person slightly moves in a range that is determined in advance or a state in which a person moves a hand, a leg, the neck, or the like.

Note that it is not necessarily necessary to use a scheme in which the sensitivity of the human-presence sensor 28 is adjusted after the meaning of the term “still” is defined as described above. The sensitivity of the human-presence sensor 28 may be comparatively roughly and typically adjusted, and may depend on the detection state of the human-presence sensor 28.

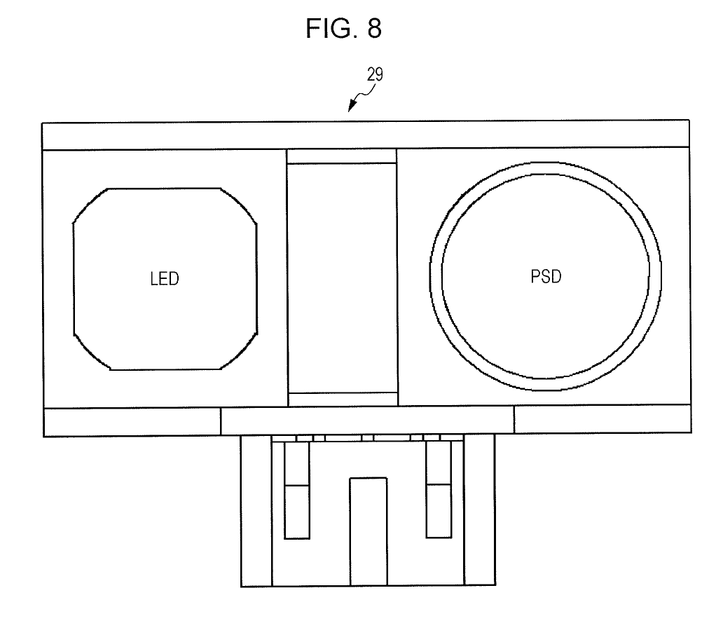

Moreover, a human-presence sensor 29 may also be provided in the during-power-saving monitoring control section 24. The specification of the human-presence sensor 29 may include detection of presence/non-presence (existence/non-existence) of a person. Such a sensor that detects presence/non-presence of a person is typified by, for example, a reflection-type sensor including a light-projecting unit and a light-receiving unit. Note that a configuration in which the light-projecting unit and the light-receiving unit are separated from each other may be used. Here, as the light-projecting unit, for example, a light emitting diode (LED) may be used, and as the light-receiving unit, for example, a position sensitive detector (PSD) may be used. FIG. 8 illustrates an example of the human-presence sensor 29 including an LED used as the light-projecting unit and a PSD used as the light-receiving unit.

The most distinctive feature of such a reflection-type sensor is that the reflection-type sensor reliably detects presence/non-presence of a person in accordance with whether or not light that is to enter the light-receiving unit is interrupted. Furthermore, because the amount of light entering the light-receiving unit is limited by the amount of light projected from the light-projecting unit or the like, the detection region of the reflection-type sensor is a comparatively short region.

Here, the human-presence sensor 28, which is mounted in the image processing apparatus 10 according to the present exemplary embodiment, is connected to the during-power-saving monitoring control section 24 as described above. A detection signal output from the human-presence sensor 28 is input to the during-power-saving monitoring control section 24.

In the during-power-saving monitoring control section 24, the human-presence sensor 28 distinguishes, on the basis of the detection signal output from the human-presence sensor 28, whether a person is approaching, and further distinguishes whether the person intends to perform an operation. Additionally, it is supposed that the human-presence sensor 29 is also provided in the during-power-saving monitoring control section 24. In this case, when the human-presence sensors 28 and 29 detect that a body capable of movement (a person) reaches a position which is located within a predetermined distance from the image processing apparatus 10 to approach the image processing apparatus 10 and that the body capable of movement (the person) becomes still, the during-power-saving monitoring control section 24 determines, on the basis of detection signals output from the human-presence sensors 28 and 29, that the body capable of movement (the person) intends to perform an operation on the image processing apparatus 10.

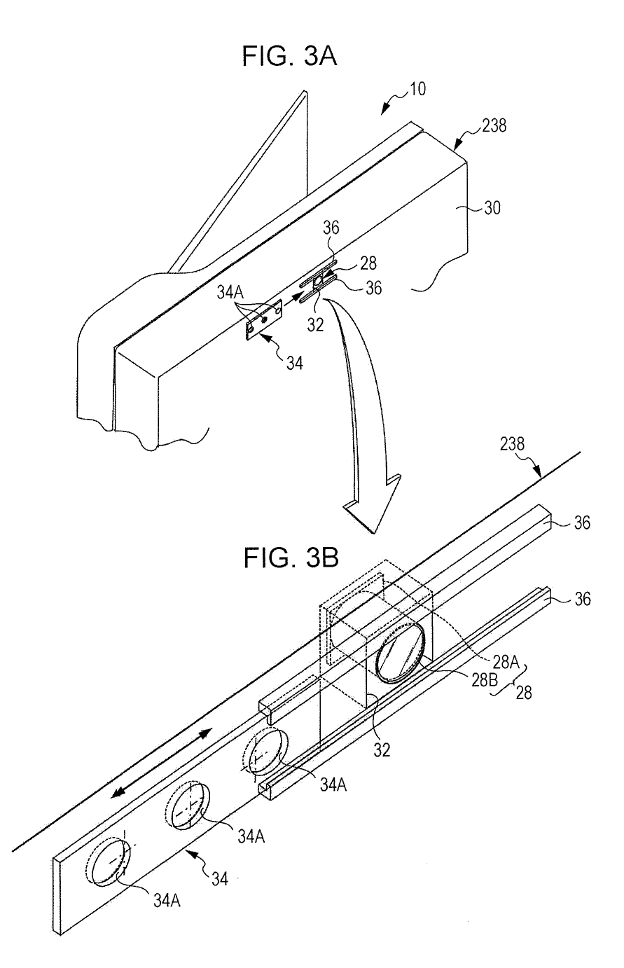

As illustrated in FIG. 3A, an operation panel is provided on the front side on the top face of the image reading section 238 of the image processing apparatus 10, and, basically, the human-presence sensor 28 is fixedly attached onto the rear-face side of the image reading section 238 so as to correspond to the operation panel, i.e., fixedly attached onto the underside of the image reading section 238.

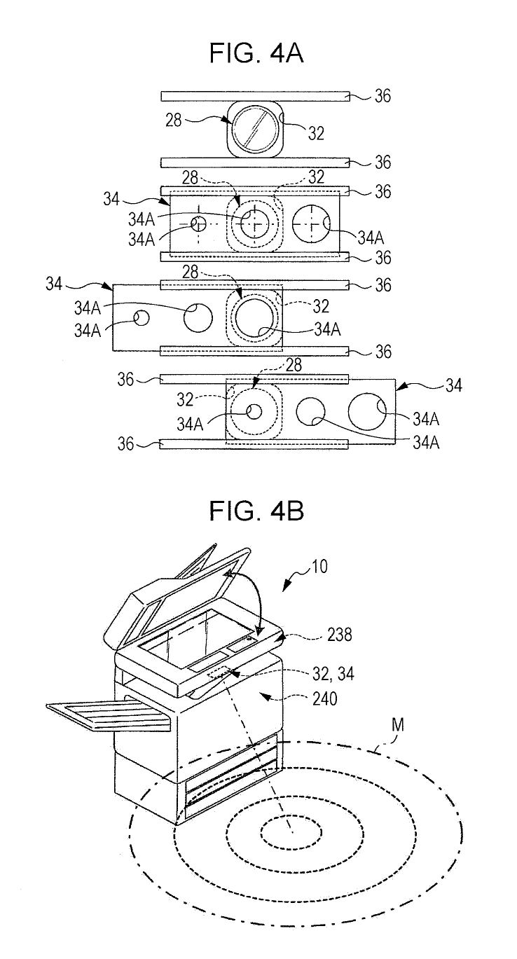

The detection optical axis of the human-presence sensor 28 is oriented to a region in which it is expected that a user who stands up in front of the image processing apparatus 10 and who performs an operation exists, and in which is located in front of the image processing apparatus 10. Basically, the detection region of the human-presence sensor 28 is a maximum region M in which movement or existence/non-existence of a person is detected by the human-presence sensor 28 (see FIGS. 4A to 7B).

Regarding the image processing apparatus 10, movement of a person may differ in accordance with a place in which the image processing apparatus 10 is disposed. In other words, movement of a person may differ in accordance with the environment of a place (for example, an office) in which the image processing apparatus 10 is disposed. Because movement of a person may differ in accordance with the environment, there is a high probability that a target to be detected by the human-presence sensor 28 may be a person (for example, a person who simply passes by the image processing apparatus 10, or a person who does not move to be near the image processing apparatus 10) other than a person who performs an operation on the image processing apparatus 10 in reality.

For this reason, in the present exemplary embodiment, a structure is used, in which multiple types of elements including a detection direction, a detection region, the shape (contour) of the detection region of the human-presence sensor 28 can be adjusted in accordance with a state in which the image processing apparatus 10 is disposed. The detection region is limited with respect to the maximum region M by adjusting the multiple types of elements.

FIG. 3 illustrates an attachment structure for attaching the human-presence sensor 28 onto the underside of the operation panel of the image processing apparatus.

A rectangular groove 32 for attaching the human-presence sensor 28 is attached onto an underside portion 30 of the operation panel. In the groove 32, the human-presence sensor 28 is accommodated.

As illustrated in FIG. 3B, the human-presence sensor 28 includes a flat plate-shaped circuit board part 28A and a tubular detection part 28B. The end of the detection part 28B has a detection face. The circuit board part 28A is in contact with the bottom face of the groove 32, and is fixed. As a result, the detection face of the detection part 28B is positioned at an opening of the groove 32. Note that, in the present exemplary embodiment, the optical axis of the detection face of the detection part 28B is fixedly arranged so as to be perpendicular to the principal plane of the circuit board part 28A. However, for example, the detection part 28B may be attached so that the detection part 28B can swing with respect to the circuit board part 28A, whereby a configuration in which the optical axis of the detection face is changed without restriction may be used. In this case, the position of the maximum region M (see FIGS. 4B to 7B), which is described below, is changed without changing the size of the maximum region M. Note that examples of a scheme for changing the optical axis without restriction include a multiaxial structure, a ball-joint structure, and a flexible arm structure. The scheme is not particularly limited thereto.

Masks 34 are selectively disposed on the edge of the groove 32 so as to face the detection face of the detection part 28B of the human-presence sensor 28. In each of the masks 34, openings 34A having different opening areas, different opening positions, and different opening shapes can be formed. In FIG. 3B, a mask 34 in which three openings 34A are formed is illustrated as an example, and the openings 34A have opening positions which are shifted from the attachment reference centers so that a circle corresponding to the detection face and the openings 34A are relatively eccentric. The detection region of the human-presence sensor 28 is limited with respect to the maximum region M by attaching the mask 34 (see FIGS. 4B to 7B).

In the periphery of the groove 32, a pair of guiding members 36 are attached in parallel to each other in such a manner that each of the grooves 32 is oriented along a corresponding one of a pair of sides that face each other.

The guiding members 36 have a bar shape. The cross section thereof that is perpendicular to an axis thereof is formed so as to be substantially L-shaped. The guiding members 36 are attached so as to be bilaterally symmetric.

The mask 34 slides from ends of the guiding members 36 in the longitudinal direction by being guided by the pair of guiding members 36. Attachment reference centers (see alternate long and short dash lines in cross shapes illustrated in FIG. 3B) are set at three points on the mask 34. Positioning is performed on the mask 34 so that one of the attachment reference centers coincides with the optical axis of the detection face of the detection part 28B.

Note that, although depending on the state of the frictional resistance between the mask 34 and the guiding members 36 when the mask 34 slides, preferably, after the above-mentioned positioning is performed, the mask 34 is fixed on the periphery of the groove 32 using a commonly known detachable structure. As an example of the commonly known detachable structure, the mask 34 may be screwed into the periphery of the groove 32, be fastened with clips on the periphery of the groove 32, or be held using elastic force on the periphery of the groove 32.

Note that patterns of the masks 34 (see FIGS. 4A to 7B), which are described below, are set by classifying basic shapes of openings 34A on a shape-by-shape basis. However, masks may be prepared, in which individual shapes of openings are set in a complex manner (for example, a pattern in which an opening having a small area and having a shifted optical axis, an opening having an opening position shifted to the left and having a large opening area, and so forth are set).

Note that, for example, a mask 34 in which no opening exists may be prepared. A template with a pattern in which shapes of openings are set is made in accordance with a place in which the image processing apparatus 10 is disposed. On the basis of the template, the mask 34 may be processed in a site of placement of the image processing apparatus 10. Furthermore, the mask 34 may be processed without restriction and without using the template.

Furthermore, a control device provided with a program for which a region that a user desires to detect is input and which is used to perform arithmetic processing in order to calculate the most appropriate shape of an opening 34A may be mounted, or a serviceman may carry the control device.

The detection region of the human-presence sensor 28 is limited with respect to the maximum region M by attaching each of the masks 34. Accordingly, in accordance with a place in which the image processing apparatus 10 is disposed, whether a user is approaching the image processing apparatus 10 for the sake of performing an operation on the image processing apparatus 10 or not for the sake of performing an operation on the image processing apparatus 10 is determined with a determination accuracy using the detection region that is limited with respect to the maximum region M. It is highly probable that the determination accuracy in this case is increased, compared with a determination accuracy with which whether a user is approaching the image processing apparatus 10 for the sake of performing an operation on the image processing apparatus 10 or not for the sake of performing an operation on the image processing apparatus 10 is determined using the maximum region M.

FIGS. 4A to 7B illustrate patterns, in which various shapes of openings 34A are set, of masks 34.

FIGS. 4A and 4B illustrate a pattern of a mask 34 in which openings 34A having different opening areas are formed. States illustrated from the top of FIG. 4A are as follows: a state in which the mask 34 is not attached; a state in which the detection face is masked by an opening 34A having a relatively median opening area; a state in which the detection face is masked by an opening 34A having a relatively large opening area; and a state in which the detection face is masked by an opening 34A having a relatively small opening area.

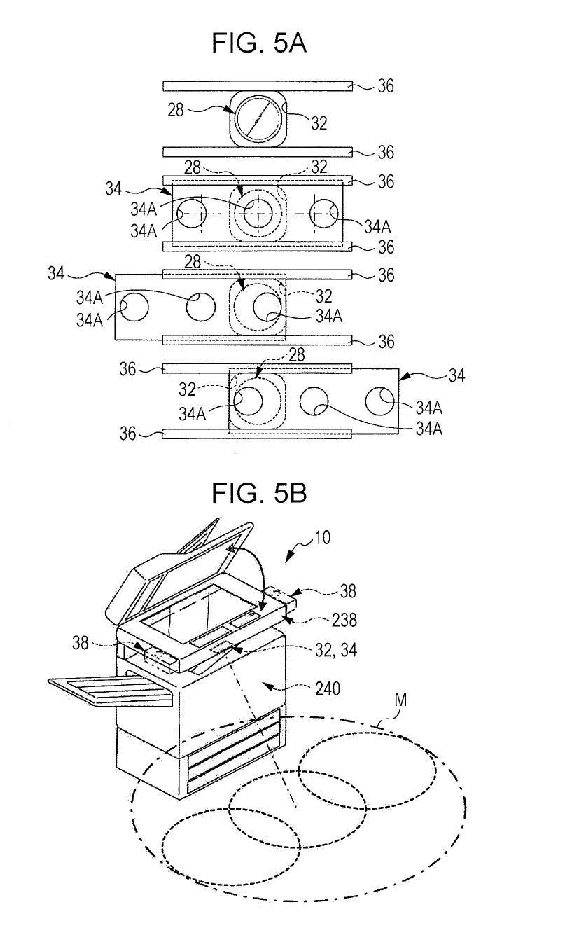

FIGS. 5A and 5B illustrate a pattern of a mask 34 in which openings 34A having limited opening areas and having opening centers that are differently positioned so as to be shifted to the left and right sides are formed. States illustrated from the top of FIG. 5A are as follows: a state in which no mask 34 is attached; a state in which the detection face is masked by an opening 34A having an opening position that is not shifted from the attachment reference center so that the circle corresponding to the detection face and the opening 34A are not relatively eccentric; a state in which the detection face is masked by an opening 34A having an opening position that is relatively shifted from the attachment reference center to the left side so that the circle corresponding to the detection face and the opening 34A are relatively eccentric; and a state in which the detection face is masked by an opening 34A having an opening position that is shifted from the attachment reference center to the right side so that the circle corresponding to the detection face and the opening 34A are relatively eccentric.

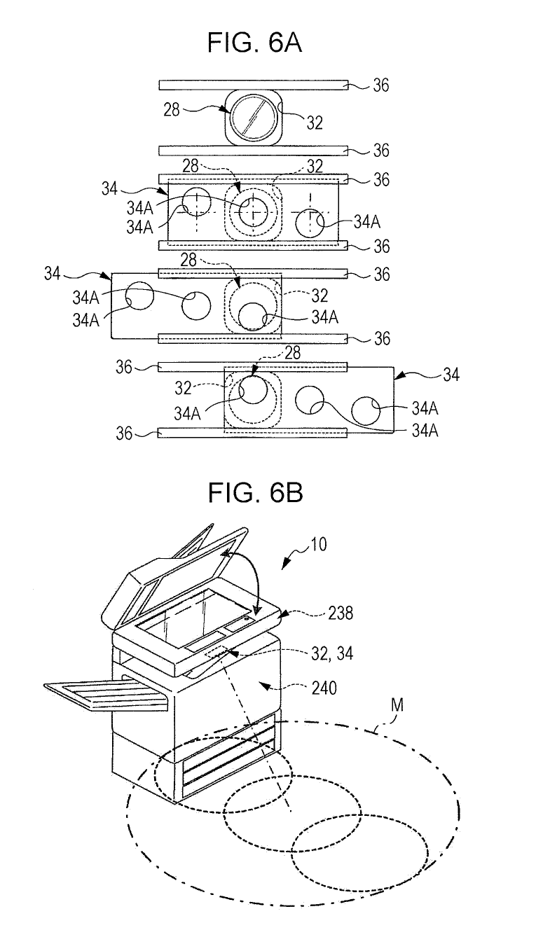

FIGS. 6A and 6B illustrate a pattern of a mask 34 in which openings 34A having limited opening areas and having opening centers that are differently positioned so as to be shifted to the front and rear sides. States illustrated from the top of FIG. 6A are as follows: a state in which no mask 34 is attached; a state in which the detection face is masked by an opening 34A having an opening position that is not shifted from the attachment reference center so that the circle corresponding to the detection face and the opening 34A are not relatively eccentric; a state in which the detection face is masked by an opening 34A having an opening position that is relatively shifted from the attachment reference center to the front side so that the circle corresponding to the detection face and the opening 34A are relatively eccentric; and a state in which the detection face is masked by an opening 34A having an opening position that is shifted from the attachment reference center to the rear side so that the circle corresponding to the detection face and the opening 34A are relatively eccentric.

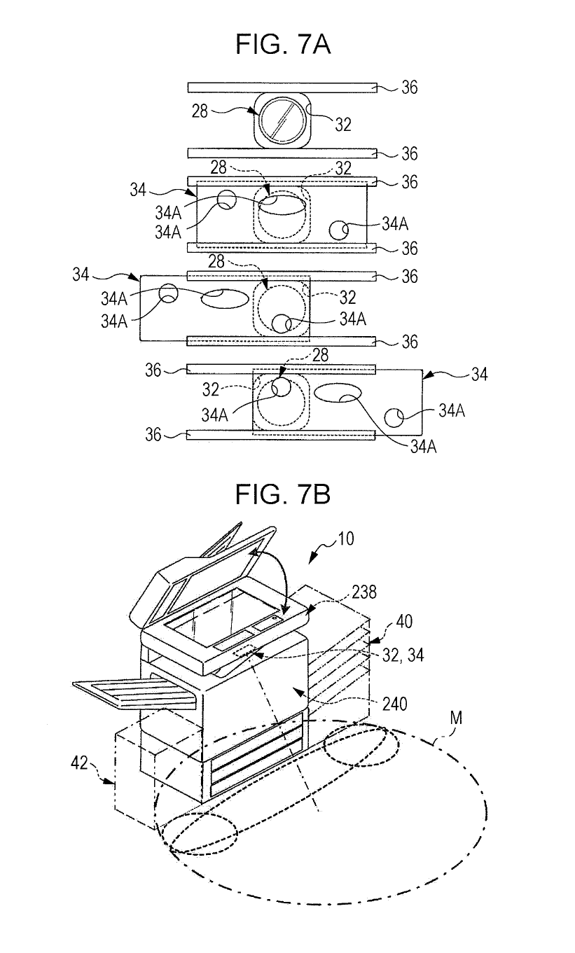

FIGS. 7A and 7B illustrate a pattern of a mask 34 in which openings 34A are formed without restriction. States illustrated from the top of FIG. 7A are as follows: a state in which no mask 34 is attached; a state in which the detection face is masked by an opening 34A having a flat shape; a state in which the detection face is masked by an opening 34A corresponding to a pinpoint relatively positioned on the left side of an apparatus; and a state in which the detection face is masked by an opening 34A corresponding to a pinpoint relatively positioned on the right side of an apparatus.

Actions in the present exemplary embodiment will be described below.

In the image processing apparatus 10 in the present exemplary embodiment, when conditions determined in advance are satisfied, shifting to the power saving mode is performed. In the power saving mode, not only supply of power to the individual devices, which are the facsimile-communication control circuit 236, the image reading section 238, and the image forming section 240, is interrupted, but also supply of power to the main controller 200 excluding the during-power-saving monitoring control section 24, and the UI touch panel 216 is interrupted. In this case, the function of the power-saving cancel button 26 connected to the main controller 200 is also stopped. Accordingly, the image processing apparatus 10 enters a state that is equivalent to a state in which a main power switch is completely turned off when the image processing apparatus 10 is viewed from the surroundings thereof. In other words, the image processing apparatus 10 enters a state in which, by viewing from the surroundings thereof, it can be made sure that the power saving mode is assuredly set (realization of “visualization”).

Here, in the present exemplary embodiment, for a trigger for resuming supply of power to the image processing apparatus 10 that is set in the power saving mode as described above, the surroundings of the image processing apparatus 10 are monitored by the human-presence sensor 28. Whether a person is approaching the image processing apparatus 10 for the sake of performing an operation or not for the sake of performing an operation is distinguished, and whether or not supply of power is to be resumed is determined.

Regarding detection of a person with the human-presence sensor 28, in a case of resuming supply of power to the image processing apparatus 10 during the power saving mode, as a matter of course, preferably, a person detected by the human-presence sensor 28 is a user who is to perform a certain operation on the image processing apparatus 10. However, depending on the detection region of the human-presence sensor 28, a situation in which supply of power to the image processing apparatus 10 does not need to be resumed in reality can be considered, such as a situation in which a person passes through the vicinity of the image processing apparatus 10, or a situation in which a person passes by the image processing apparatus 10 without performing an operation on the image processing apparatus 10 even when the person approaches the image processing apparatus 10. One of the reasons for this is a place in which the image processing apparatus 10 is disposed. In other words, when the image processing apparatus 10 is placed in a narrow passage, every time a person passes through the passage, the human-presence sensor 28 may detect the person. Furthermore, it is supposed that two or three directions from the image processing apparatus 10 are blocked by disposing the image processing apparatus 10 along columns or by disposing the image processing apparatus 10 in a recessed place. In such a case, even when a person who intends to perform an operation on the image processing apparatus 10 approaches the image processing apparatus 10, the human-presence sensor 28 may be unable to detect the person.

Alternatively, attachment of an optional device with which the external shape of the image processing apparatus 10 is changed may cause so-called blind spots in the detection region of the human-presence sensor 28. Examples of the optional device include an IC card reader 38 (see FIG. 5B), an automatic sorting device 40 (see FIG. 7B), and a large-capacity sheet storage device 42 (see FIG. 7B).

For this reason, in the present exemplary embodiment, a structure is provided, in which the detection region of the human-presence sensor 28 is adjusted with a simple configuration in accordance with a place or state in which the image processing apparatus 10 is disposed. Basically, a structure is provided, in which the human-presence sensor 28 is attached onto the image processing apparatus 10, and in which the detection region of the human-presence sensor 28 is limited by blocking one portion of the detection face of the detection part 28B of the human-presence sensor 28. In the present exemplary embodiment, multiple masks 34 are provided, and, in each of the masks 34, three types of openings 34A are formed.

Hereinafter, the usage of each of the masks 34 will be described with reference to FIGS. 4A to 7B.

Note that the state in which no mask is attached is a state in which the utilization of the detection face of the detection part 28B of the human-presence sensor 28 is maximized (the maximum region M illustrated in each of FIGS. 4B to 7B). The state in which no mask is attached is suitable for a case of reliably and quickly detecting a person approaching the image processing apparatus 10 with the human-presence sensor 28 in a comparatively large place in which the image processing apparatus 10 is disposed.

As illustrated in FIG. 4A, in the mask 34, openings 34A having different opening areas are formed as a pattern (in which the following openings 34A are set: an opening 34A having a relatively median opening area; an opening 34A having a relatively large opening area; and an opening 34A having a relatively small opening area). When the mask 34 is caused to slide along the pair of guiding members 36, detection regions, the shapes of which are coaxial circles having different radii, can be set as illustrated in FIG. 4B. Accordingly, in a case in which a place in which the image processing apparatus 10 is disposed is a passage, a detection region is selected, by causing the mask 34 to slide, among the four types of detection regions including the maximum region M in accordance with the width of the passage or the like, and is set.

As illustrated in FIG. 5A, in the mask 34, openings 34A having limited opening areas and having opening centers that are differently positioned so as to be shifted to the left and right sides are formed as a pattern (in which the following openings 34A are set: an opening 34A having an opening position that is not shifted from the attachment reference center so that the circle corresponding to the detection face and the opening 34A are not relatively eccentric; an opening 34A having an opening position that is relatively shifted from the attachment reference center to the left side so that the circle corresponding to the detection face and the opening 34A are relatively eccentric; and an opening 34A having an opening position that is shifted from the attachment reference center to the right side so that the circle corresponding to the detection face and the opening 34A are relatively eccentric). When the mask 34 is caused to slide along the pair of guiding members 36, three detection regions can be set along the width direction of the image processing apparatus 10 as illustrated in FIG. 5B.

Accordingly, for example, it is supposed that the IC card reader 38 used for an authentication process is disposed on either the left or right side of the image reading section 238 of the image processing apparatus 10, and that a first operation which is to be performed on the image processing apparatus 10 is necessarily the authentication process. In this case, the detection region may be set in accordance with a place (the right or left side of the image reading section 238) at which the IC card reader 38 is disposed.

As illustrated in FIG. 6A, in the mask 34, openings 34A having limited opening areas and having opening centers that are differently positioned so as to be shifted to the front and rear sides are formed as a pattern (in which the following openings 34A are set: an opening 34A having an opening position that is not shifted from the attachment reference center so that the circle corresponding to the detection face and the opening 34A are not relatively eccentric; an opening 34A having an opening position that is relatively shifted from the attachment reference center to the front side so that the circle corresponding to the detection face and the opening 34A are relatively eccentric; and an opening 34A having an opening position that is shifted from the attachment reference center to the rear side so that the circle corresponding to the detection face and the opening 34A are relatively eccentric). When the mask 34 is caused to slide along the pair of guiding members 36, three detection regions can be set along the depth direction of the image processing apparatus 10 as illustrated in FIG. 6B.

Accordingly, for example, it is supposed that the image processing apparatus 10 is disposed along columns or in a recessed place, and that a person who intends to perform an operation on the image processing apparatus 10 approaches the image processing apparatus 10 from the front of the image processing apparatus 10. In this case, by causing the mask 34 to slide in a direction of a passage along which the person approaches the image processing apparatus 10, a detection region is selected among the three types of detection regions, and is set.

Note that, in FIG. 4A to 6B, the openings 34A have circular shapes. However, the shapes of the openings 34A are not limited thereto. Examples of the shapes of the openings 34A include rectangular shapes, polygonal shapes, elliptic shapes, and star shapes. Furthermore, two or more openings may be formed at one type of position in a mask.

As illustrated in FIG. 7A, in the mask 34, openings 34A are formed without restriction as a pattern (in which the following openings 34A are set: an opening 34A having a flat shape; an opening 34A corresponding to a pinpoint relatively positioned on the left side of an apparatus; and an opening 34A corresponding to a pinpoint relatively positioned on the right side of an apparatus). When the mask 34 is caused to slide along the pair of guiding members 36, three detection regions can be set in accordance with a place in which the image processing apparatus 10 is disposed or a state in which an optional device is attached to the image processing apparatus 10 as illustrated in FIG. 7B.

For example, when the opening 34A having a flat shape is used, it is supposed that the image processing apparatus 10 is disposed in a narrow passage in a state in which an optional device (the automatic sorting device 40 or the large-capacity sheet storage device 42) is attached to the left or right side of the image processing apparatus 10. In this case, the length of the detection region in the depth direction is set to be short in the front of the entirety of the image processing apparatus 10 including the optional device. Accordingly, a person passing on a side, which is opposite a side on which the image processing apparatus 10 is disposed, of the passage is not detected, and a person approaching the image processing apparatus 10 is detected. Note that, in this case, for example, when a person approaches the image processing apparatus 10 in order to supply sheets to the large-capacity sheet storage device 42 serving as the optional device, in order to cause the human-presence sensor 28 to detect the person, it is only necessary that the person reach the front of the large-capacity sheet storage device 42. A sheet supply state is recognized by the main controller 200 to which power is supplied again.

Note that, in the present exemplary embodiment, a configuration is used, in which an opening 34A is selected by causing the mask 34 to slide along the guiding member 36 for the human-presence sensor 28 that is fixed. However, a configuration may be used, in which openings 34A or multiple detection-face limiting parts that are equivalent thereto are formed in advance in the image processing apparatus 10, in which one or multiple detection-face limiting parts are selected among the detection-face limiting parts, and in which one or multiple human-presence sensors 28 are attached.

Furthermore, movement of the masks 34 is not limited to linear sliding. As a matter of course, a configuration in which the masks 34 are replaced one by one may be used. For example, a so-called turret system may be used, in which multiple openings 34A are formed on the edge of a disc, and in which an opening 34A is selected by causing the mask 34 to rotate. Furthermore, the human-presence sensor 28 may be supported on a stand capable of being three-dimensionally moved, and the degree of flexibility of adjustment of the optical axis of the detection face may be increased.

Moreover, in the present exemplary embodiment, power during the power saving mode (power utilized to activate the during-power-saving monitoring control section 24) is supplied from the mains power source 242. However, if the during-power-saving monitoring control section 24 operates using power supplied from an internal battery, a solar cell, or a rechargeable battery that is charged during the power supply mode, supply of power from the mains power source 242 is completely interrupted in the power saving mode.

Furthermore, referring to FIG. 2, a configuration is used, in which power is supplied on a device-by-device basis to devices (the facsimile-communication control circuit 236, the image reading section 238, the image forming section 240, and a portion of the main controller 200, the UI touch panel 216, and so forth) that are necessary for each processing function which is specified, or supply of power to the devices is interrupted on a device-by-device basis. However, for example, a configuration may be used, in which power is supplied to all of the devices in the power supply mode, and in which, in contrast, power can be supplied to only at least the human-presence sensor 28 and a monitoring control system therefor (the during-power-saving monitoring control section 24) in the power saving mode.

Moreover, a state in which the human-presence sensor 28 is attached, and in which the possibility of determination of a user approaching the image processing apparatus 10 for the sake of using the image processing apparatus 10 is high may be determined on the basis of detection-history information concerning the detection history of bodies capable of movement detected by the human-presence sensor 28. Furthermore, in a case in which adequate power is ensured in the power supply mode or the power saving mode, a configuration may be used, in which the detection direction of the human-presence sensor 28 or movement of a mask 34 for the sake of selecting an opening 34A can be automatically adjusted using a drive source, such as a motor, on the basis of the detection-history information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A power-supply monitoring device comprising:
a power-supply control section that receives supply of power from a mains power source section, and that selectively sets a power supply mode and a power saving mode, the power supply mode being a mode in which power is supplied to a processing section that operates using power supplied from the mains power source section, the power saving mode being a mode in which supply of power to the processing section is stopped;
a detection section that detects a body capable of movement in a predetermined region which is set in a periphery of the processing section, the body capable of movement including a user who intends to use the processing section;
a determination section that determines, when the body capable of movement is detected by the detection section, whether or not switching from the power saving mode to the power supply mode is to be performed;
a control section that controls the power-supply control section on the basis of a result of determination performed by the determination section; and
an attachment section that is attached to the detection section so that a detection region is adjustable, the detection region including a position or having an area for identifying the user who intends to use the processing section.

2. The power-supply monitoring device according to claim 1, wherein the attachment section includes a mask that limits the detection region by shielding a portion of a detection face of the detection section, and adjusts the detection region in accordance with a position at which the mask is attached.

3. The power-supply monitoring device according to claim 2, further comprising
a guide section that is capable of changing a relative position between the mask and the detection section,
wherein a plurality of shapes used for the detection region are formed in the mask in advance, and the plurality of shapes used for the detection region, which are formed in the mask, are selectively used by performing relative movement between the mask and the detection section with the guide section.

4. The power-supply monitoring device according to claim 1, wherein a device which is capable of being attached later and with which an exterior contour of the entirety of the processing section is changed is detachably attached to the processing section, and the detection region is adjusted in accordance with a state in which the device capable of being attached later is attached.

5. The power-supply monitoring device according to claim 2, wherein a device which is capable of being attached later and with which an exterior contour of the entirety of the processing section is changed is detachably attached to the processing section, and the detection region is adjusted in accordance with a state in which the device capable of being attached later is attached.

6. The power-supply monitoring device according to claim 3, wherein a device which is capable of being attached later and with which an exterior contour of the entirety of the processing section is changed is detachably attached to the processing section, and the detection region is adjusted in accordance with a state in which the device capable of being attached later is attached.

7. An image processing apparatus comprising:
the power-supply monitoring device according to claim 1; and
at least one of an image reading section, an image forming section, and a facsimile-communication control section, the image reading section reading an image from a document image, the image forming section forming an image on a recording sheet on the basis of image information, the facsimile-communication control section transmitting an image to a transmission destination in accordance with a communication procedure which is mutually determined in advance,
wherein the image reading section, the image forming section, and the facsimile-communication control section perform each of image processing functions by cooperating with each other, the image processing functions being specified by a user and including an image reading function, an image forming function, an image copy function, a facsimile reception function, and a facsimile transmission function.
